(19) United States
(12) Patent Application Publication
(10) Pub. No.: US 2004/0060616 A1
(43) Pub. Date: Apr. 1, 2004

(54) Method for setting the feed position in a disc chipper based on the size of logs being chipped and disc chipper suited for implementing the method

(76) Inventors: Arvo Jonkka, Pori (FI); Antti Tohkala, Pori (FI)

Correspondence Address: BURNS DOANE SWECKER & MATHIS L L P, POST OFFICE BOX 1404, ALEXANDRIA, VA, 22313-1404, US

(21) Appl. No.: 10/467,826

(22) PCT Filed: Feb. 13, 2002
(86) PCT No.: PCT/FI02/00114

(30) Foreign Application Priority Data
Mar. 16, 2001 (FI) 20010537

(51) Int. Cl. B27C 1/00; B27M 1/08; B27C 9/00; B27L 11/00

(52) U.S. Cl. 144/373; 144/172

(57) ABSTRACT

The present invention relates to a method for setting the conditions in the feed chute of a disc chipper according to the size of wood to be chipped. The position of the chipping anvil at the outlet end of the chute is changed in a plane which is essentially parallel to the plane of the knife disc in regard to a diagonal of the knife disc parallel to the plane of the anvil so that the inclination of the chipping plane of the anvil towards the blade disk remains substantially unchanged. Furthermore, the position of the feed chute bottom in the chipper may be adjusted to comply with the changed position of the chipping plane, where necessary.

The present invention relates to a method for setting the feed position in a disc chipper and a chipper suited thereto. A disc chipper is commonly used in the paper and pulp industry for chipping wood prior to further processing. In a chipper equipped with a chute feeder, logs are fed along an inclined, curved chute against the knife disc of the chipper. The knife disc rotates about a horizontal or inclined axis. Logs slide against the knife disc gravitationally or under forced feed. On the knife disc are mounted knives that are aligned substantially radially for chipping wood against a stationary counter knife formed as an anvil bar.

The logs fed into the chipper meet the knife disc at a spout angle that in a chute-fed chipper is defined as the angle subtended between the log in the spout and the knife disc plane in a plane perpendicular to the knife disc plane. Tests have shown that the quality of chips is improved if the spout angle between the log and the knife disc is made smaller. However, a limit to further reduction of the spout angle is set by the increase of the area of the cut surface ellipse at the end of the log that in turn causes a reduction of the feed chute cross section unless the inlet opening of the chute is not respectively enlarged. Furthermore, it has been found through practical experience that feed disturbances at the chipper occur more frequently with a small spout angle, since the chipping area at the log end increases and the feed-stabilizing effect of gravity decreases. Factors related to the feed chute design and behavior of logs during chipping, as well as forces imposed on logs being chipped, are discussed in European patent publication EP 893216.

Major problems in modem chipper constructions arise from the need for a larger feed chute and varying size and quality of wood to be chipped. These problems cause a failure of controlled infeed of logs in chippers based on conventional techniques. While small pilot-scale chippers may give a good chipping result at small spout angles, the chipping quality achievable in mass-production size chippers remains substantially inferior. Furthermore, the extremely robust construction of chippers employed in mills prevents the use of easily adjustable feeder constructions.

Chipper manufacturers have attempted to solve the problems by developing various feed techniques different from conventional constructions, but these feed methods have proven handicapped by the uncontrolled movement of logs particularly in the lateral direction. The magnitude of the lateral movement is the greater the smaller the log length and diameter. Firstly, thin logs have more space to move laterally. Secondly, the length of logs is eventually reduced during chipping so that at final phase, the short bolts can readily assume a new position even rotating by 90°, whereby slivers will be cut instead of chips of a desired size.

The characterizing features of one embodiment of the present method according to the invention are disclosed in the appended claim 1 and a chipper suited to implement the method is disclosed in claim 3. A further embodiment of the method according to the invention is disclosed in the appended claim 6.

In a chipper according to the invention, the cutting conditions can be adapted as required to meet the actual running situation by virtue of easily modifiable feed settings of the chipper.

Next, the invention will be examined in greater detail by making reference to the attached drawings, wherein

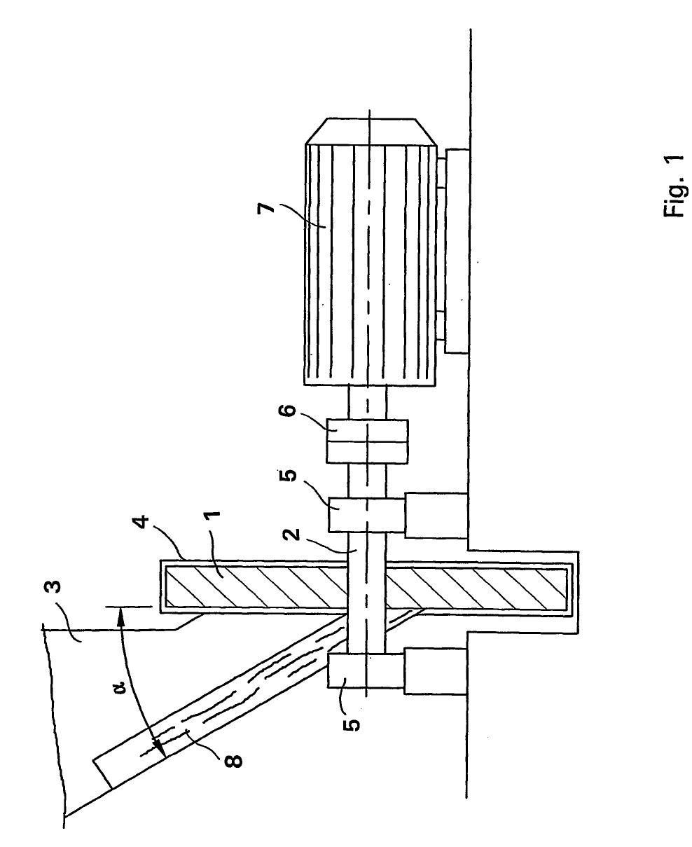

FIG. 1 shows a side view of log feed into the chipper in a conventional feed construction;

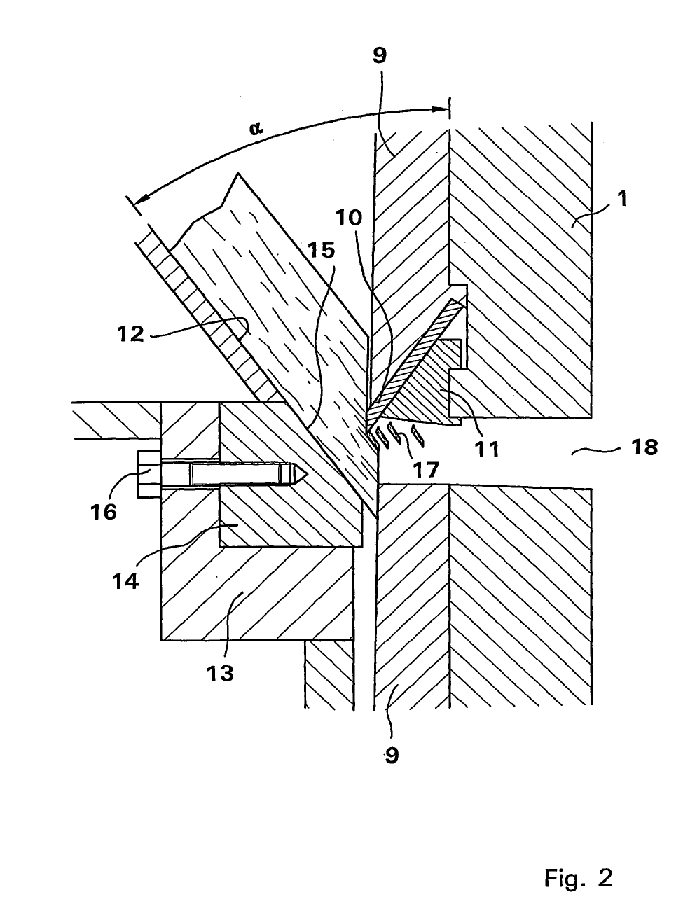

FIG. 2 shows a conventional knife system of a disc chipper;

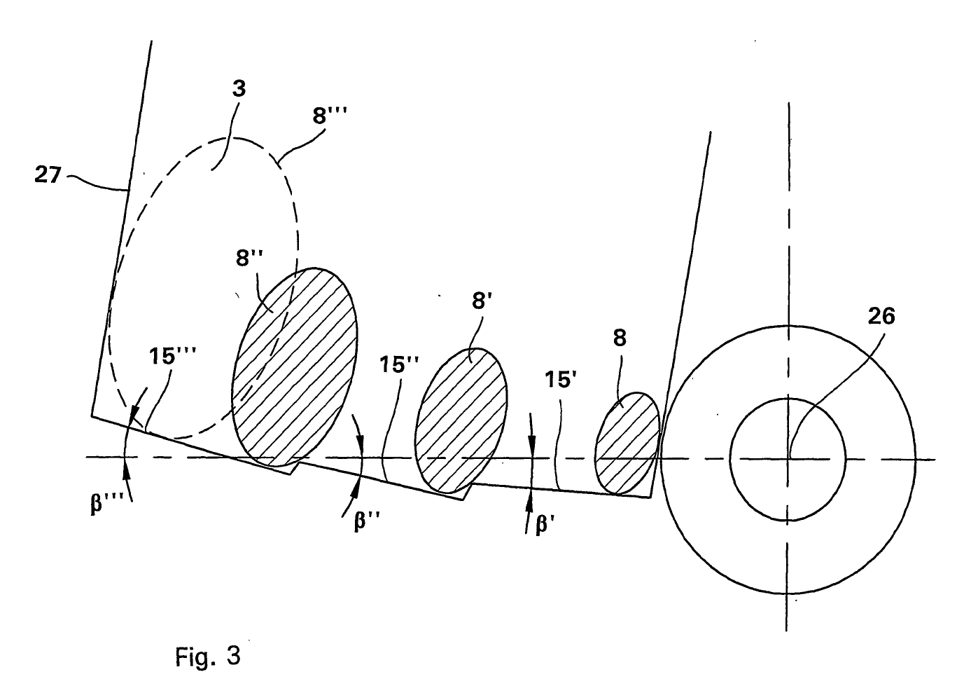

FIG. 3 shows a sectional view of the profiles of a modem anvil bar and feed chute in the knife disc plane;

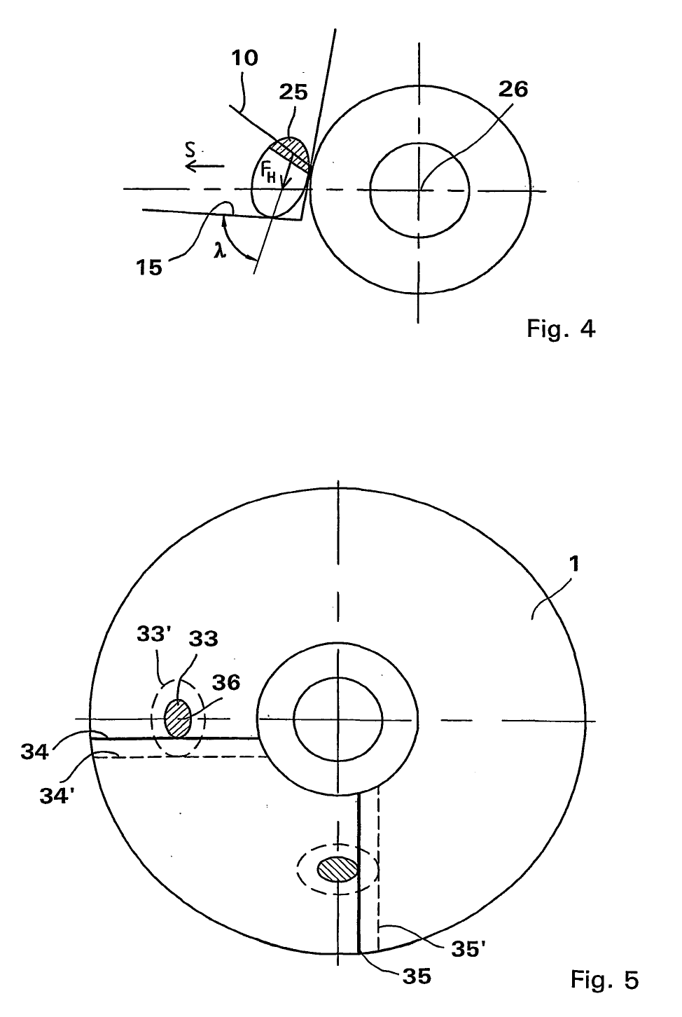

FIG. 4 shows the beginning of log chipping in the feed chute of a disc chipper;

FIG. 5 shows a preferred position of the anvil bar in two chippers having different log feed arrangements;

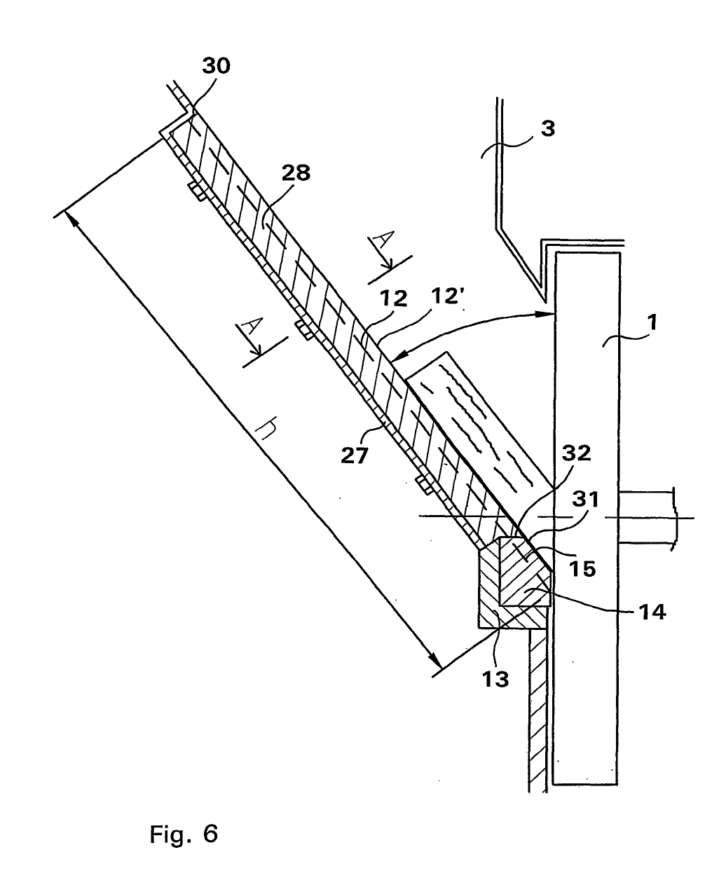

FIG. 6 shows a feed chute according to the invention; and

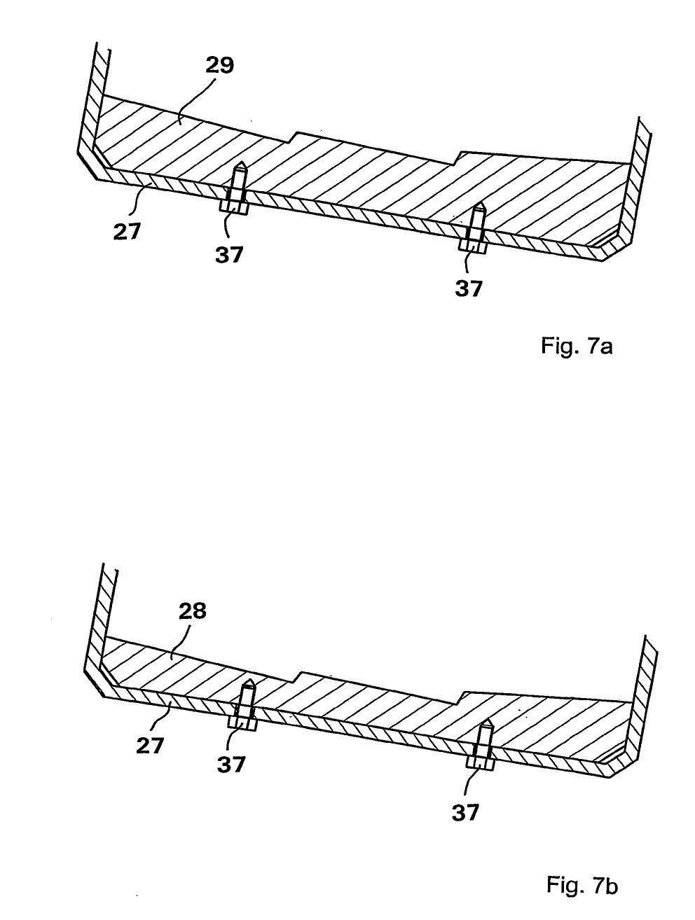

FIGS. 7 and 7a show a sectional view of FIG. 6 taken in the plane A-A.

In FIG. 1 is illustrated a disc chipper conventionally used for chipping wood. The chipper comprises a knife disc 1, a shaft 2, a feed chute 3, a casing 4 and bearings 5. The chipper drive system comprises a coupling 6 and a motor 7. The logs 8 to be chipped are fed into the chipper so that the log 8 fed into the chipper forms an angle a with the knife disc.

In FIG. 2 is shown a conventional chipper knife system. Herein, the knife disc 1 has wear liner plates 9 attached thereto. The chipper knives 10 are clamped in place by means of a knife holder 11. The support structure of the feed chute bottom 12 provides top-side support for a counter knife 14, whose chipping surface 15 is contoured to follow the shape of the feed chute bottom 12 so as to form a spout extension of the feed chute, whereby the reaction forces of chipping are received by the chipping surface that due its fast wear is made easily replaceable by being fixed by screws 16 to a support block 13. Logs 8 are fed against wear liner plate 9, whereby knives 10 cut off chips 17 that are removed along an opening 18 made to knife disc 1. To obtain high-quality chips, it is necessary assure that logs 8 meet the knife disc in a correct position so that angle α stays constant and no lateral movement of logs can take place.

Today, the massive production rate of modem industry needs chippers capable of chipping plural logs simultaneously. To this end, chippers such as those shown in FIG. 3 have been constructed with a wide feed chute and an almost horizontal chipping surface 15 of the counter knife. Herein, chipping takes place almost over the entire width of the counter knife. In the feed chutes of the type shown in FIG. 3, wood infeed is implemented via plural feed stations so that a reliable and steady wood infeed control is attained also on a wide infeed chute. The operation of this kind of chipper is described in patent publication EP 893216.

The feed shute of the chipper according to the present invention can have a contour such as that shown in FIG. 3, for instance, wherein logs 8, 8′, 8″ are guided toward the correct direction for chipping in the separate feed stations that are adapted to operate in parallel at the upper surface of the counter knife. Wood infeed into the chipper takes place so that a major portion of the logs slide gravitationally at the point denoted by log 8 (FIGS. 3 and 4) toward the knife disc 1. The leading end of log 8 meets the knife disc and, at the beginning of chipping, a small cut area 25 is formed, whereby the cutting force FH shown in FIG. 4 is imparted toward the surface of the counter knife 15 so that the lambda angle λ between the force vector F_{H} and the surface 15 of the anvil knife remains substantially smaller than 90° thus forcing the log 8 to slide in the direction denoted by arrow S outwardly away from the center 26 of the knife disc under the effect of the scissors force imposed on the log.

For a large log, the effect of the scissors force is very powerful causing the log to seek the chipping position of log 8″ shown in FIG. 3 so as to become pressed against the outermost counter knife portion 15′″ or, alternatively, against the outer side wall 27 of the feed chute 3 in the position of log 8′″. Medium-size logs 8′ seek in the feed station to rest against counter knife portion 15″ while small logs remain in the feed station in the position drawn as log 8, because the knives meet the small logs so late that no outwardly-acting forces are imparted on small logs. The above-kind of movement of logs outwardly from the center of the knife disc must be unhindered as is the case in the construction illustrated in FIG. 3.

The feed chute shown in FIG. 3 operates at a very high infeed capacity and varying sizes of logs with the provision that the height of the top surface 15 of the counter knife 15 is selected properly in regard to the position of the knife disc center 26 and the log diameter. However, the chipper running conditions may vary. This takes place when, for instance, the incoming logs change so as to have a diameter smaller than the average, the forces imparted on the logs tend to move them preferentially toward the knife disc center 26 and the inner wall of the feed chute. Resultingly, chipping does not any more occur uniformly over the entire width of the counter knife 14. Rather, logs accumulate against the inner wall of the chute and, hence, the logs piled on each other do not get a sufficiently good support from the counter knife. Furthermore, a small-diameter log resting against the inner wall of the feed chute is subjected to forces that tend to move the trailing end of the log toward the outer wall 27 of the feed chute. Due to these reasons, logs begin to move erratically during chipping thus undermining the chip quality. Also the average size of chips cut in the chipper at the inner wall of the feed chute increases inasmuch the chipping speed is there smaller than at the center or outer wall of the feed chute.

On the other hand, if the incoming logs change so as to have a diameter larger than the average, the logs tend to move toward the outer wall of the feed chute, whereby even in this case the chipper does not use effectively the entire width of the anvil knife. Also the average length of chips becomes shorter as the chipping speed is higher.

In the method according to the invention, the counter knife 14 is adapted replaceable according to the optimum feed height requirement of the chipper. In FIG. 5 are shown in a chipper with radial cutting knives the positions of the chipping edge 34, 34′ of the counter knife as the anvil knife should preferably be adjusted for small-diameter logs 33 and, respectively, for large-diameter logs 33′. The positions 34, 34′ of the counter knife in a vertical-feed chipper of gravitational log feed are located at the side of the knife disc. In a horizontal-feed chipper using a feed conveyor, the positions 35, 35′ of the counter knife are generally located at the lower part of the knife disc. In either one of these feed arrangements, the chipping edge 34, 34′ (35, 35′) of the counter knife is selected such that the center 36 of the elliptical cut surface of either size of log is in the same position.

In FIGS. 6, 7 and 7a is shown a technique implemented in the method according to the invention for changing the level of feed chute surface 12 carrying the logs being chipped when the level of the counter knife is elevated. In the case that the diameter of the entering logs becomes smaller than the average, the counter knife 14 is set to a higher level, whereby the edge level 15 of the counter knife assumes a new level position 31. Respectively, the level 12 of the feed chute bottom is elevated into a new level position 12′ compliant with the new level position 31 of the counter knife so that the counter knife will not form a threshold for the travel of logs toward the knife disc during chipping. After the changes are made in the position of the counter knife 14 and the feed chute bottom 12, chipping can be continued in a uniform manner over the entire width of the counter knife notwithstanding the reduction in the average diameter of the logs being chipped. In a preferred embodiment, the level of the feed chute bottom 12 is elevated by way of replacing the bottom plate 28 with a thicker bottom plate 29, wherein the slanting angles β′, β″ and β′″ (FIG. 3) of the surfaces 15′, 15″ and 15′″, respectively, mating with the counter knife are made different from those of the first bottom plate 28 so as to better serve the new chipping position. Alternatively and in particular when the need to raise the bottom plate level is minor, pads can be placed under the bottom plate 28 so as to displace more upward from the base structure 27 of the feed chute, whereby the level of the feed chute is elevated without the need for replacing the bottom plate 28. Generally, the elevation adjustment range of the feed chute is 30 to 150 mm in the radial direction of the log.

The bottom plate can be mounted on the feed chute base structure 27 by screws 37 or other suitable means. Alternatively, the bottom plate can be hingedly fixed by its upper end 30, whereby the lower end 32 of the bottom plate becomes rotatable about the pivot point at the upper end 30. The bottom plate can be machined from a single plate as shown in FIGS. 7 and 7a or, alternatively, be comprised of a welded structure. The overall length “h” of the feed chute bottom plate 28, 29 with the counter knife 14 is selected such that it exceeds the length of the logs to be chipped in order to avoid a change in the spout angle α of logs when a shallower counter knife with a thinner bottom plate 28 is used.

Respectively, when logs of a larger diameter are to be chipped, the normal counter knife is replaced with a shallower one, whereby the chipping position descends in regard to the knife disc center 26. Simultaneously, the normal bottom plate of the feed chute is replaced by a thinner one. Thus, the method according to the invention can provide optimum chipping conditions under variations in the wood material parameters.

The feed chute bottom plate is subject to wear in the fashion as the easily replaceable counter knife. In conventional disc chippers, the feed chute is conditioned by welding beads or new plate on the worn area. Such repair operations must be performed 12 to 3 times per year depending on the wood species being chipped. In conventional chippers, the repair of the feed chute is complicated and time-consuming inasmuch the welding operations must be carried out in the narrow chute. In contrast, the method according to the invention makes servicing easy, since the bottom part of the feed chute can be dismounted from the chute proper thus facilitating uncomplicated repair at a workshop. If so desired, a spare can be stored for the replacement of the bottom plate, whereby it can be changed rapidly.

The chipper according to the invention facilitates the adjustment operations to be carried out without changes in the basic structures of the chipper.

What is claimed is:

1. A method for setting the feed conditions in a disc chipper according to the size of wood to be chipped, the chipper having an essentially horizontally located drive shaft, a knife disk rotated on the shaft in a plane perpendicular to the shaft, the knife disk carrying on its one plane surface cutting blades extending essentially radial from the rotation center of the knife disk, a feed chute for the logs to be chipped, the feed chute having an inclination towards the disk, an in-feed opening at its elevated end, an outlet opening at its lower end toward the blade carrying side of the blade disk, a bottom extending essentially between the openings, and a counter knife at the lower edge of the outlet opening, the counter knife forming an anvil with a chipping plane coinciding with the chute bottom, characterized in that the position of the chipping plane in the chipper is changed in a plane which is essentially parallel to the plane of the knife disc in regard to a knife disc diagonal parallel to the plane of the counter knife so that the inclination of the chipping plane remains substantially unchanged and that the position of the feed chute bottom in the chipper is adjusted to comply with the changed position of the clipping plane at least in the vicinity of the counter knife.

2. The method of claim 1, characterized in that the desired position of the chipping plane of the counter knife is set by way of using counter knives of different sizes.

3. A chipper suited to implement the method of claim 1 or 2, the chipper having an essentially horizontally located drive shaft, a knife disk rotated on the shaft in a plane perpendicular to the shaft, the knife disk carrying on its one plane surface cutting blades extending essentially radial from the rotation center of the knife disk, a feed chute for the logs to be chipped, the feed chute having an inclination towards the disk, an in-feed opening at its elevated end, an outlet opening at its lower end toward the blade carrying side of the blade disk, a bottom extending essentially between the openings, and a counter knife at the lower edge of the outlet opening, the counter knife forming an anvil with a chipping plane coinciding with the chute bottom, characterized in that the bottom of the feed chute of the chipper is designed adjustable to comply with the chipping plane of the counter knife.

4. The chipper of claim 3, characterized in that the feed chute bottom comprises a changeable bottom plate.

5. The chipper of claim 4, characterized in that the shape (15′, 15″, 15′″) of the chute bottom plate surface is selected according to the thickness of the bottom plate.

6. A method for setting the feed conditions in a disc chipper according to the size of wood to be chipped, the chipper having an essentially horizontally located drive shaft, a knife disk rotated in a rotation direction on the shaft in a plane perpendicular to the shaft, the knife disk carrying on its one plane surface cutting blades extending essentially radial from the rotation center of the knife disk, a feed chute for a forced in-feed of the logs to be chipped, the feed chute having a sharp spout angle towards the disk, an outlet opening at its end toward the blade carrying side of the blade disk, and a counter knife at the edge of the outlet opening projecting in the rotation direction of the blade disk, the counter knife forming an anvil with a chipping plane coinciding with the spout angle, characterized in that the position of the chipping plane in the chipper is changed in a plane which is essentially parallel to the plane of the knife disc in regard to a knife disc diagonal parallel to the plane of the counter knife so that the spout angle of the chipping plane remains substantially unchanged.
